(19) United States
(12) Patent Application Publication
(10) Pub. No.: US 2007/0150484 A1
(43) Pub. Date: Jun. 28, 2007

(54) Systems and methods for multi-media transfer

(76) Inventors: John Liam Funge, Washington, DC (US); Leo Jenkins Scott, Arlington, VA (US)

Correspondence Address: MOAZZAM & ASSOCIATES, LLC, 7601 LEWINSVILLE ROAD, SUITE 304, MCLEAN, VA, 22102, US

(21) Appl. No.: 11/642,652

(22) Filed: Dec. 21, 2006

Related U.S. Application Data
(60) Provisional application No. 60/752,886, filed on Dec. 23, 2005.

(51) Int. Cl. G06F 17/30

(52) U.S. Cl. 707/10

(57) ABSTRACT

Systems and methods are presented for sharing multi-media applications and files on line. A central server acts as the receiving, organizing and playing point for multi-media applications from multiple users having authorized access to a particular member's secure position within the central server.

This U.S. Utility Patent Application claims priority to U.S. Provisional Patent Application Ser. No. 60/752,886, filed Dec. 23, 2005, the content of which is hereby incorporated by reference in its entirety into this disclosure.

### BACKGROUND OF THE INVENTION

1. Field of the Invention

The present invention relates to multi-media transfer. More particularly, the present invention relates to online digital media sharing and internet-based communications.

2. Background of the Invention

The capturing and sharing of images is as old as history itself. Thousands of years ago, humans recorded what they saw with cave drawings. In the 19^{th} century, photography gave us tools other than paint and brush. Throughout the 20^{th} century, still images started to move. Though photography and movie making have been mainstream for decades, we have not yet begun to see the full potential of what will happen when digital technologies sweep away cost and technology barriers associated with film and tape-base media.

In particular, the digitalization of photography and videography blurs the line between the two. Already, most consumer “one-click” digital cameras have both still image and video modes. With the ever increasing capacity of removable memory cards (the “film” of the future), the average digital camera will soon be able to take both high quality still images as well as hours of digital video. Add to this the fact that the majority of mobile phones in the future will include high quality photo and video capture, and it's easy to see that we are at the beginning of a new era of pervasive image capture.

Armed with the ready ability to take either photos or video, consumers will prefer efficiency and will opt to store and share all their media in one place, although this has not been the way people have managed their personal media to date. For mostly technological reasons, people typically have kept photos and videos separate. The former going into shoeboxes and albums, the latter stuffed in a case near a television. As the technical barriers between photos and video dissolve, the inventors envision that people will want to do the logical thing: keep all their memories together—regardless of the format. After all, though new cameras will enable people to seamlessly shoot multiple formats, people will still be attending just one soccer game or just one wedding. When it comes to sharing, customers will insist on having everything together as well so as to not create a hassle for family and friends.

As new cameras blur the line between photography and videography, another seminal trend is poised to redefine how we record history: the network connected camera. Until only very recently, cameras were independent devices whereby any transmission of the media from the camera involved some form of film processing or manual media transfer. As camera manufactures have started adding networking capabilities to digital cameras, they have unleashed the ability to transfer the photos and video off the camera with the simple push of a button. In particular, wirelessly connected cameras are creating an entirely new mode of personal media sharing: “in-context” personal media sharing. As regular digital cameras become Wifi-enabled and more and more people adopt cameraphones, snapping a photo and immediately sending it to family or friends—directly from the camera—will become commonplace.

Though online services for sharing personal media exist, these services fall short of the needs driven by the trends mentioned above. First, existing services lack the necessary level of cross-media integration. Existing services are for sharing either photos or video. What is needed is a service that provides a complete and tightly integrated toolset for seamlessly sharing and managing multiple types of media. Second, existing solutions provide only rudimentary ways of communicating directly with the shared media storage area. As files become larger and increasing numbers of people transmit personal media directly from their camera to the media storage platform, a growing need will emerge for more sophisticated mechanisms for transmitting media both from the camera to the media sharing service as well as from the media sharing service to others.

Thus, a need exists in the art of capturing and sharing multi-media files on line as well as between persons. The technique should be efficient, easy to use, and universally accessible so as to be used and accessed worldwide with minimal training and instructions. Furthermore, the technique should allow the user the flexibility to present files in any type, order, and time sequence as desired by the user.

### SUMMARY OF THE INVENTION

The present invention discloses systems and methods for uploading, editing, managing, and sharing of digital media. This invention overcomes shortcomings in the prior art by providing a higher level of integration and a superior user interface for seamlessly handling and presenting multiple media formats—such as, for example, photographs and videos. Additionally, this invention advances the art through the degree to which photographers and videographers can transmit content directly from their camera to a pre-defined storage and sharing area—as well as transmit media from the storage area to other connected hosts.

In certain exemplary embodiments, the present invention includes a central server, processor and/or computer system to support exemplary methods and systems outlined herein. As well, in certain exemplary embodiments, the invention embodies the communications network required to connect between multiple hosts and the system. One having ordinary skill in the art would be cognizant of the server configuration and requirements after having understood the invention as described herein.

Techniques described herein provide the ability to upload media of multiple types (such as photos and videos) to an online storage area. The invention provides security permissions so as to limit access to the online storage area in accordance to the specific preferences of a particular user. Within one user account, a user is able to create multiple logical groups, which can be storage areas (or “albums”) so as to better organize media. Such a logical group is formed through a combination of folders on a server as well as some relational database storage. Each storage area may be assigned a unique user-defined email address. Media can be sent directly to a storage area by emailing the content as an attachment. Thus, a particular user may have multiple albums for better organization, each album with its own unique email address used to send media thereto. Users may also synchronize content between the online storage area and other hosts in accordance with user-defined synchronization rules. The account holder can set upload permissions such that only certain users can upload to the online storage area whether through the email method, synchronization, or using standard web-based upload tools of the system.

In certain exemplary embodiments, the invention allows each storage area to be shared over the internet by assigning the appropriate permissions. The user can select from a library of pre-defined look and layout templates in order to customize the appearance of the shared view of the online storage area.

The invention enables viewers of a shared storage area to browse multiple media formats through a unique user interface convention that distinguishes between photos and video. Further, shared storage area viewers can view the content through a multimedia slideshow presentation that can play a series of photos and/or video in sequence automatically without the viewer needing to advance from one item to the next.

The invention enables those who are viewing a shared storage area to subscribe to that storage area. In this way, each online storage area can have an associated list of subscribers. The invention can send subscribers email updates of new media that is added to the online storage area in accordance with user-defined subscription rules.

The invention provides for the ability to use the media stored in the online storage area to create rich-HTML emails or MMS messages. The invention provides a library of look and layout templates from which a user can customize the rich-HTML email or MMS message. The invention automatically embeds resized images into the email in accordance with the selected email template. The email provides HTML links back to the respective media.

The invention further provides the ability to create a rich-HTML email or MMS message based on a video selected from the online storage area. The invention allows the user to manually create still images from frames within the video, or alternatively the invention can automatically create a series of still images from frames within the video content. The invention then provides the ability for the user to select or de-select the screen “grabs” the user wants to include in the rich-HTML email. The user can then customize the format of the rich-HTML email by selecting a look and layout from the library of looks and layouts. The invention automatically embeds the selected images from the video into the email in accordance with the selected email template. The email provides HTML links back to the respective video.

The invention also embodies an ordering process whereby users can order photo prints, specialty merchandise, and backup copies of the specified media items in the online storage area. The invention enables the users to define permissions whereby users can allow others to order items as well as set limits on ordering activity. The invention provides a process whereby users can pre-pay for specific number of items.

The invention also embodies a process for transferring media from removable memory cards that are mailed to an operations center and matching the media with the correct respective user account.

### BRIEF DESCRIPTION OF THE DRAWINGS

FIG. 1 shows a schematic of a sharable online storage area according to an exemplary embodiment of the present invention.

FIG. 2 shows an uploader according to an exemplary embodiment of the present invention.

FIG. 3 shows automated upload and synchronization according to an exemplary embodiment of the present invention.

FIG. 4 shows a postal mail-in process according to an exemplary embodiment of the present invention.

FIG. 5 shows a management view according to an exemplary embodiment of the present invention.

FIG. 6 shows a shared view in a thumbnail layout according to an exemplary embodiment of the present invention.

FIG. 7 shows a shared view in a rapid view layout according to an exemplary embodiment of the present invention.

FIG. 8 shows a shared view in a journal layout according to an exemplary embodiment of the present invention.

FIG. 9 shows a shared view showing a customized black look according to an exemplary embodiment of the present invention.

FIG. 10 shows a sample mail according to an exemplary embodiment of the present invention.

FIG. 11 shows an integrated multi-media slideshow according to an exemplary embodiment of the present invention.

FIG. 12 shows a playable media indicator according to an exemplary embodiment of the present invention.

FIG. 13 shows videogram creation according to an exemplary embodiment of the present invention.

FIG. 14 shows a sample “quilt” style email according to an exemplary embodiment of the present invention.

FIG. 15 shows steps involved in creating a quilt style email according to an exemplary embodiment of the present invention.

### DETAILED DESCRIPTION OF THE INVENTION

The present invention provides a more robust, more intelligent, and more versatile system for sharing and transferring of multi-media files, including pictures, audio, video, and the like. Through the use of the present invention, a user may create and/or view a multi-media show, and share such show with select users that have select permission to receive part or all of the show. Many other possibilities are within the scope of the present invention and may be gleaned from the present disclosure.

To better understand the present invention and its many uses and operations, a number of terms are used throughout this disclosure that are unique and descriptive of the present invention. The definitions of such terms as used herein and throughout this disclosure are presented as well as examples of use. One having ordinary skill in the art would understand the definitions and functions of the terms used herein after consideration of the disclosure.

One of the components of the present invention that is evident in exemplary embodiments described herein is the Multimedia Online Storage Area (also defined as the “PickleBox”). The PickleBox is the central organizing element within the system, also called “Pickle.” A user's account is made up of an Inbox and a series of PickleBoxes. PickleBoxes are where users store and share their personal media. For example, one might create a PickleBox for a child's graduation and another for a niece's wedding and yet another to hold the photos and videos from a Halloween party, and so on. Each PickleBox acts as an album for storing multi-media files related to a particular user-defined category or event. But such PickleBox is not limited to an album function.

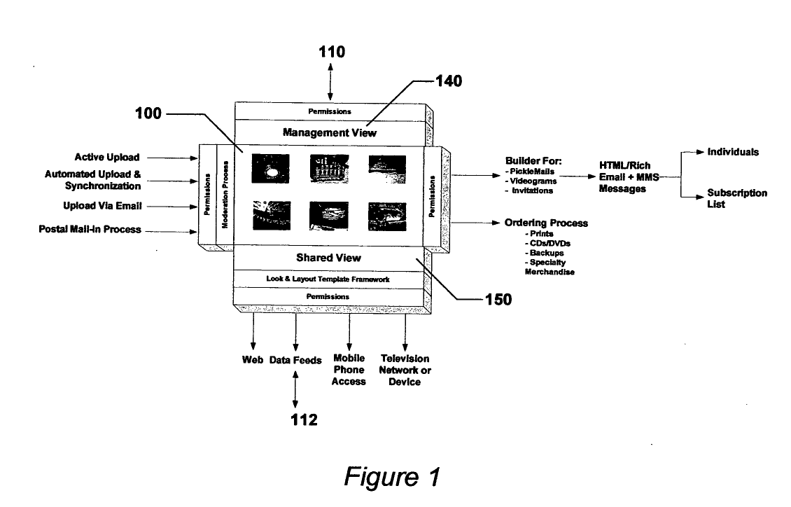

PickleBoxes provide a unique combination of elements found in an email box, an online album, a blog, and list server all in one. FIG. 1 provides an exemplary summary of the functionality that is supported by PickleBox 100. Various elements are presented in FIG. 1 having a variety of functions. For example, multiple perspective views may be selected, including a management view 140 and a shared view 150. Some of these functions are described here and others are apparent to one having ordinary skill in the art after consideration of the present disclosure.

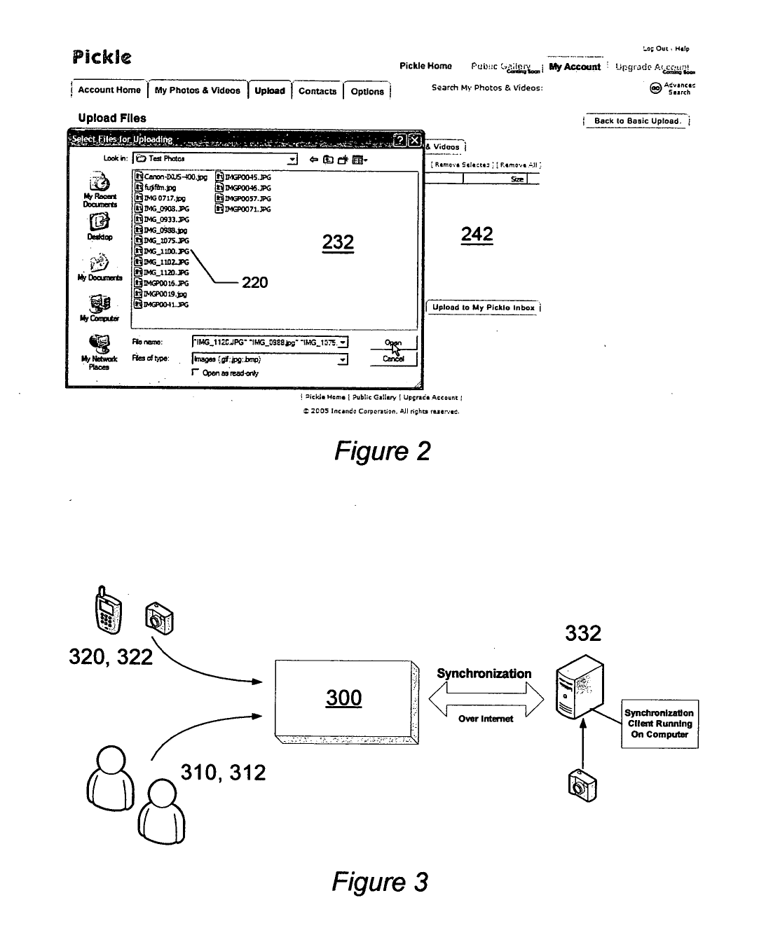

The Active Upload element refers to uploads that are initiated by the account holder 110—as opposed to automated uploads 112 which are initiated automatically by the account holder's PC or other source of data feeds, such as a mobile telephone, PDA or the Internet, or the like. In performing an active upload, the user would use the Pickle upload tools as shown in FIG. 2. This process consists generally of selecting files 220 from a files window 232 in the account holder's PC, using an Active Upload element 242.

The Automated Upload & Synchronization function, shown in FIG. 3, enables account holder 310 to specify a file, set of files, folder or set of folders, on the account holder's computer 332 that will automatically synchronize with the user's PickleBox 300. The account holder 310 can specify a schedule for the synchronization process such as having the media 320 or 322 synchronize at night. The synchronization process is multi-way. Therefore, new items that may have been uploaded to the account holder's PickleBox 300 either from another user 312 who has permission to upload content, or from the account holder 310 uploading media from another device (such as a telemobile phone or wifi camera), will be copied back to the account holder's PC 332. The synchronization process is designed to intelligently manage the synchronization load so as to optimize for speed. Smallest files are synchronized first with the largest files being synchronized last.

The function of Upload Via Email refers to the capability to email personal media directly to an account holder's Pickle account. An account holder can email to Pickle either to their account Inbox or directly to a PickleBox. The account holder has the ability to assign a different email address to every PickleBox in their account. As a result, any Pickle account may have numerous email addresses associated with different PickleBoxes within the account.

The email-in process requires a number of steps, which are apparent to one having ordinary skill in the art after consideration of the present disclosure, the steps including, but not limited to: conducting security measures to minimize space; running a virus scan; parsing the email message; extracting key data from the email message; and stripping the email of attachments and feeding the attachments into a media compression/processing server queue. After the media is processed, it is stored. As well, the email process detects if inbound emails come from certain sources which don't include the photo or video as an attachment (e.g., Sprint picture mail). Based on the source, the process may involve the additional process of fetching the media from another server on the internet and then feed it into the media compression/processing step in the process.

Although the Picklebox may be set to accept all uploads from various authorized users, a level of moderation may be applied to control content. For example, PickleBox permissions can be set to require that uploaded media be approved by the account holder before it is allowed to go into the PickleBox.

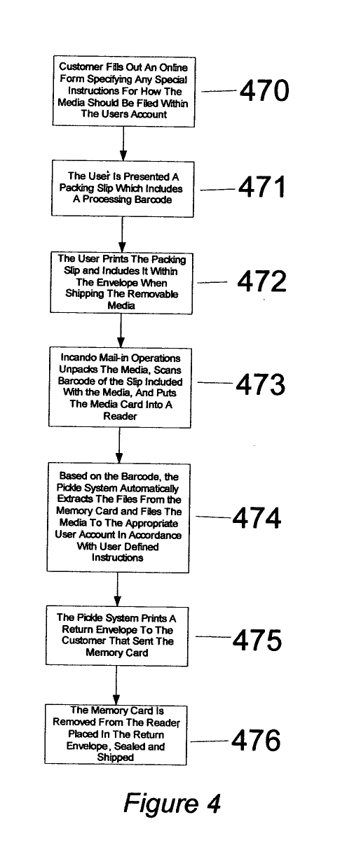

The Postal Mail-In process, as shown in FIG. 4, allows an account holder to mail memory cards from a camera to a central processing company by filling out an online form 470. The request is processed and the account holder is mailed a packing slip 471, which the account holder includes with the memory card 472. Staff at such company can then extract the contents from the memory card 473 and place it in the account holder's account 474. Once the media has been transferred, a return envelope is made 475, and the staff will mail the memory card back to the account holder in the return envelope 476. This process is designed for account holders who wish to avoid long uploads of very large files. An exemplary process that may be used is outlined in the flow chart of FIG. 4, yet other processes are also possible.

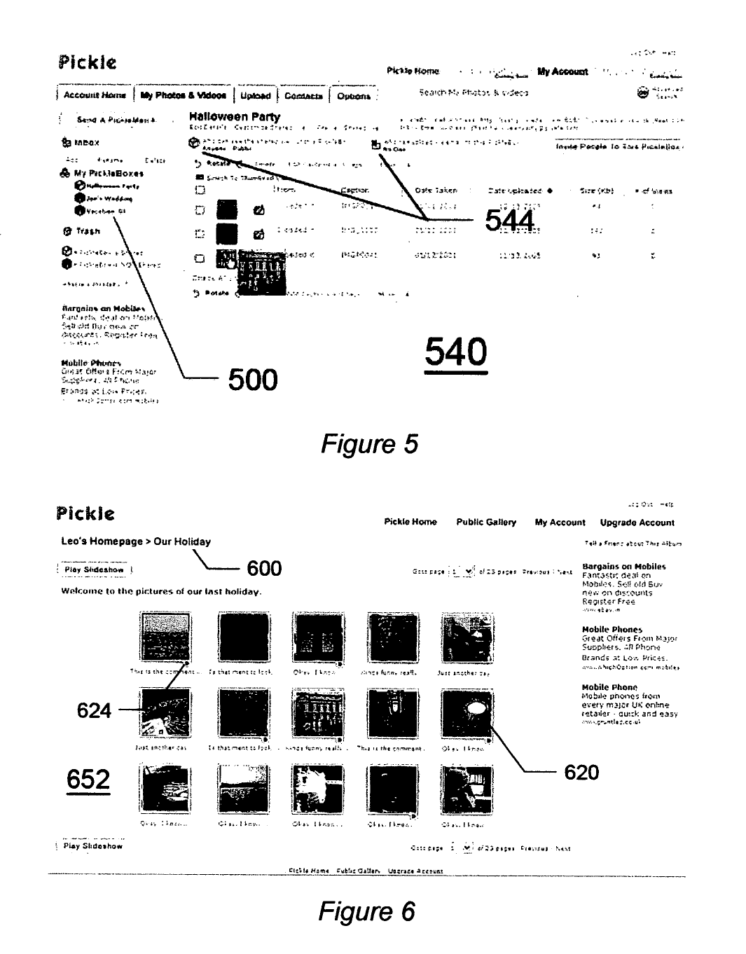

A Management View shown in FIG. 5 enables the account holder to manage the media that is in the list of PickleBoxes 500. See for example, management view 140 with respect to PickleBox 100 in FIG. 1. Management View 540 provides a condensed List View as well as a Thumbnail View.

PickleBox 500 provides a flexible array of permissions 544 that give the account holder flexible control over who can do what with their account. Permissions 544 include, but are not limited to:

Upload:
Set who can upload or email directly into the PickleBox
Set which PickleBoxes require content to be reviewed prior to inclusion in the PickleBox
Set which people can upload without approval of the uploaded content and which require approval
Set upload thresholds for those who are allowed to upload

Viewing Permissions:
Allow anyone to see the PickleBox
Allow only those who receive an invitation to view the PickleBox
Set a password to access the PickleBox
Allow a specific group to see the PickleBox

Printing Permissions:
Allow others to print or download original version of media in your PickleBoxes
Set printing thresholds for those who are allowed to print.

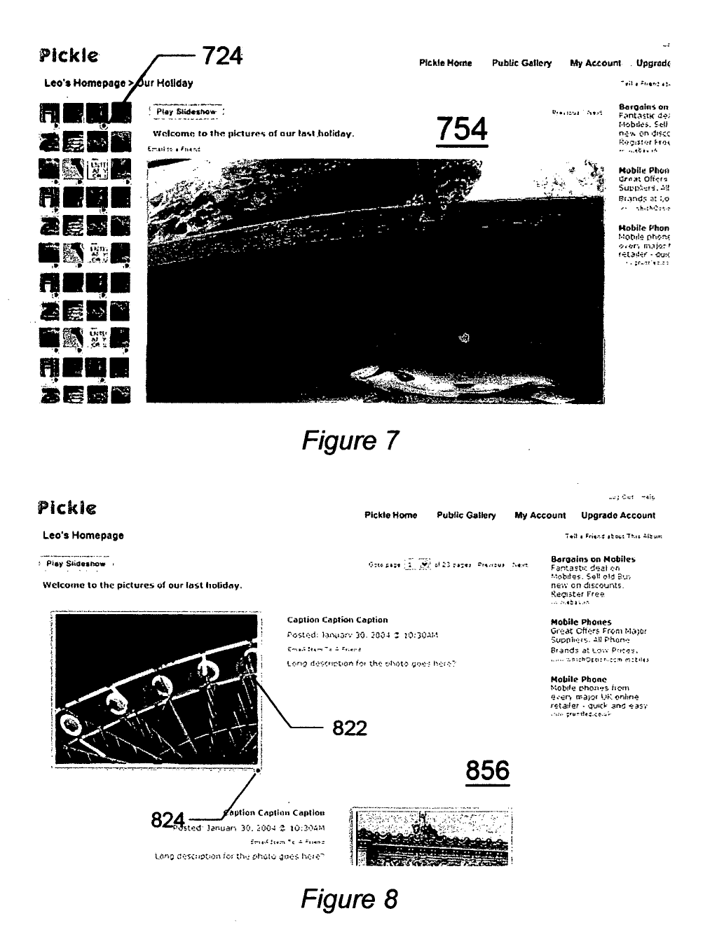

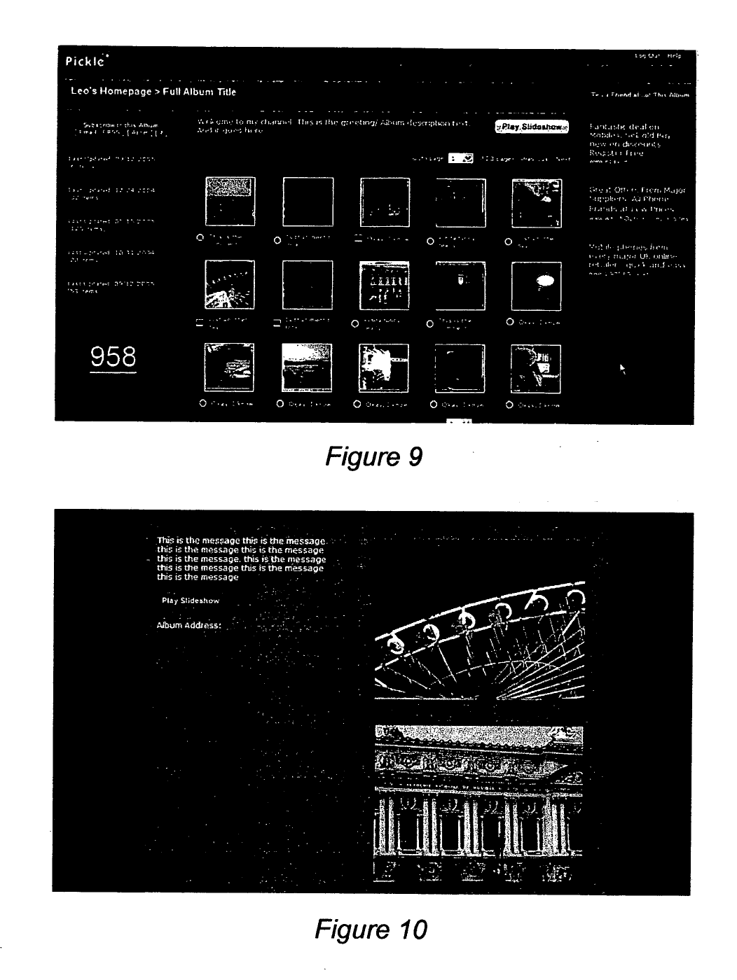

The Shared Views of a PickleBox, as shown in FIGS. 6-9, provide numerous ways that a PickleBox 600 can be presented to others. Web-based layout and look templates enable the account holder to create a customized Web-based layout for the contents within the PickleBox 600, such as thumbnail view 652, rapid view 754, journal view 856, and black view 958. Also, users can view content in PickleBoxes via data feeds (such as, for example, RSS) as well as selected mobile phones. Other views may also be possible are within the scope of the present invention.

As outlined above, shared view can be displayed in numerous configurations. In one configuration, a thumbnail layout 652, various images or video files 620 are presented in small graphics under each PickleBox 600. Video clips will have a small indicator 624 that distinguishes itself from standard photographs. In rapid view layout 754, individual photo and video files 724 are presented in small thumbnail format on one side while a larger image of the selected thumbnail is presented on the screen. In journal view 856, a file 822 is presented which could be photo or video. If the file 822 is a video file, then an indicator 824 notifies the user that this is a video file and can be pressed to view the video. In black view, 958, the photo and video files are presented with a black background to highlight the thumbnails even more.

Various types of Builders for PickleMail, Videogram, and Invitation are possible and within the purview of the present disclosure. Pickle enables users to create different types of HTML/rich emails based on the content stored in their PickleBox:

PickleMail: An HTML-based email that contains a selection media from one or more PickleBoxes. A PickleMail recipient will see thumbnail images which when clicked will bring the user to view the respective source media file. Also, the user can select the Play Slideshow button on a Pickle Mail to view a sequential slideshow presentation of all the media items included in the PickleMail. FIG. 10 is an example of what a PickleMail could look like.

Videogram: A special email that enables users to embed screen grabs from a video into an email. A more detailed discussion of the Videogram is provided below.

Invitations: HTML-based emails that embed images that link back to a specific PickleBox that a user wishes to invite others to view.

Any of the above described types of special emails created can be sent, addressed to individuals or sent to a subscription list. For the ordering process, the account holder can enable a PickleBox to allow viewers of the Shared View to order prints, CDs/DVDs, backups, and specialty merchandise using the content in a PickleBox.

Each PickleBox can have a subscription list. Viewers can sign up to be included on the subscription list while viewing the Shared View of the PickleBox. The account holder may also create and manage the subscription lists. The subscription management capability enables subscribers to receive email updates automatically when the contents of a PickleBox change. Subscribers can designate the frequency at which subscribers receive email updates to be specified.

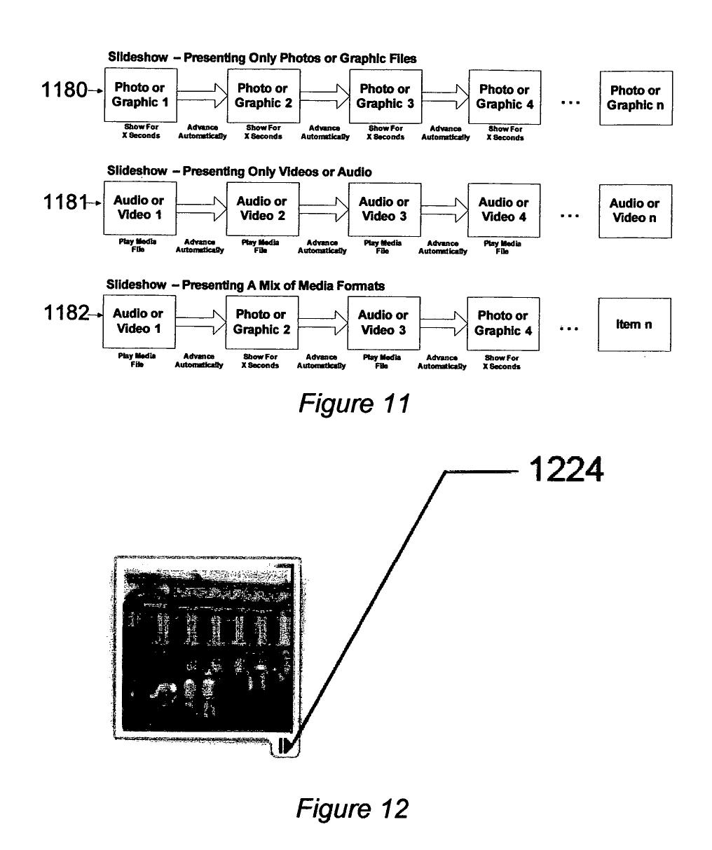

One of the many unique advantages of the present invention is the ability to prepare and present an Integrated Multimedia Slideshow. As shown in FIG. 11, Pickle provides account holders a unique integrated slideshow capability. A conventional online photo slideshow automatically advances account holders through a series of digital photos displaying each photo for a pre-designated period of time that the account holder can set. The Pickle slideshow feature is unique in that it extends the slideshow concept across a wide array of photos, videos, audio files, and graphic file formats. The account holder can elect to play a photo only slideshow 1180, where the account holder specifies a time limit for each photo to be shown. The account holder can also elect to play a video and audio only slideshow 1181, in which the slides will automatically advance after playing the audio or video file. Another option is for the account holder to make a mixed slideshow of photos and audio and video 1182 in which the account holder would specify a time limit for each photo to be shown while the slides containing audio or video advance after the media is done playing. As a result, users can select a set of photos and/or videos, hit Play, sit back and have the photos, videos, and other media play sequentially—without any further user intervention. In particular, the slideshow feature can determine when a video or audio file has finished playing and automatically present the next media file that is queued up to be viewed in the show.

The slide show player (or “PicklePlayer”) can be played from any remote site, such as other websites or mobile devices, and is designed to link directly to an appropriate PickleBox. The slide show player can periodically poll the PickleBox data feed to get information as to whether any new content has come into the PickleBox. The slide show player can then play slideshows either on the Pickle site or a slide show can be posted on to another website by the user. In this way, content that resides in a PickleBox can be viewed/played on any website.

Another aspect of the present invention is a Playable Media Indicator 1224 in the Image Border, as shown in FIG. 12. Within the Pickle user interface, both playable media (video and audio) and photos may be associated with an image. For example, clicking on one image may play a video file while clicking on another image may present an enlarged photo that is associated with the clickable image. The challenge from an application design perspective is to denote to the user which images link to still photos or graphics and which images link to playable media.

In designing the Pickle user interface, a unique technique has been devised for easily signaling to the user whether the thumbnail corresponds to playable media or not: a Play button 1224 is positioned within the border of the image. This technique is used in thumbnail sized images as well as larger images.

FIGS. 6-8 are a series of screen shots that illustrate how Pickle can use Playable Media Indicator 1224 in different contexts within the application.

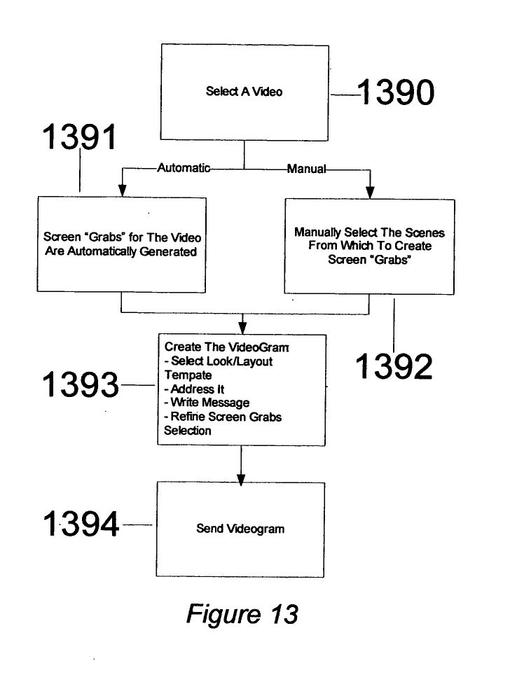

As shown in the flowchart of FIG. 13, Pickle provides users the capability to select a video from their media collection, and to easily create an email which contains screen grabs from the video. First, the account holder selects a video 1390. Then, the account holder can elect to have screen “grabs” automatically selected 1391, or manually select which screen “grabs” to include 1392. Once the screen “grabs” are selected, the account holder can complete an email 1393 and send it to their recipients 1394. In addition, a Videogram provides a link back to the video so that Videogram recipients can click on the link to view the respective video.

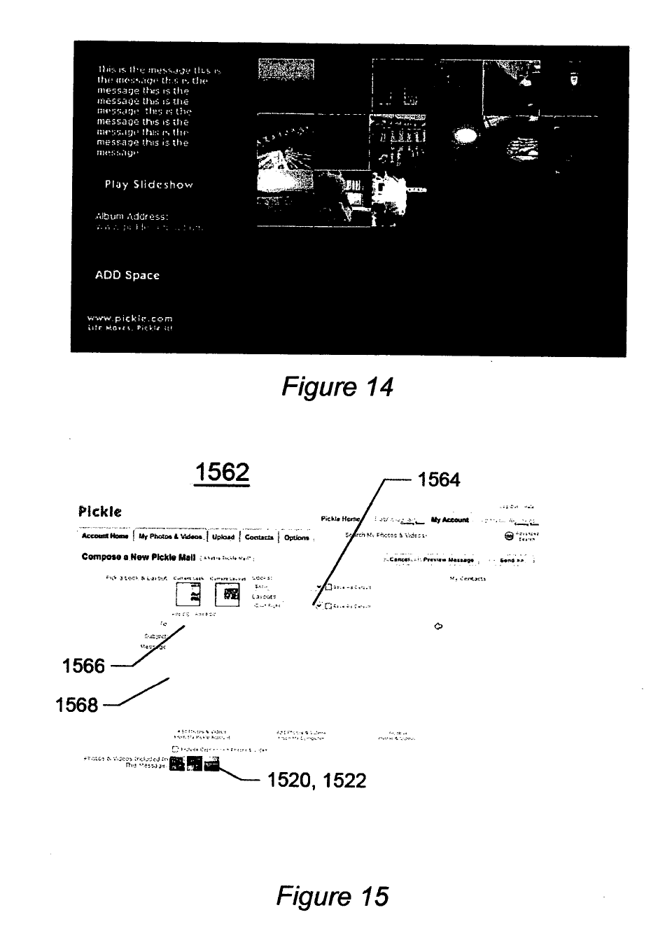

An exemplary embodiment of the PickleMail template enables an account holder to create a unique layout of images in the HTML/rich email, akin to an image quilt style format. The “quilt” layout is a layout of images that doesn't leave space between the images. The example presented in FIG. 14 shows a quilt style PickleMail layout. Although some Web-based photo albums provide this type of layout, none of them provide the ability for a user to create quilt-style email by a simple point-and-click process of selecting media 1520 and 1522 from the account holder's PickleBox 1562, layout selection 1564, address input 1566, and message body 1568, as shown in FIG. 15. The quilt layout can support any number of images as well as images of differing sizes.

In implementing the present invention in its various possible forms, Pickle utilizes industry standard Web-based application development tools and techniques in the construction of the capabilities described. Media processing and video screen grabs are accomplished using off-the-shelf media processing server technology. The PickleBox email capabilities both with regard to receiving and sending emails are implemented by thorough custom integration of standard email server technology with the Pickle system. In order to implement synchronization capabilities, Pickle makes use of a custom software client that is run on the account holder personal computer. The client works in concert with the server-based Pickle system software to provide the synchronization features.

The present invention has numerous unique features and functions that are distinguishable from any sharing system conventionally available. Such advantages include, but are not limited to: the PickleBox concept as described above and shown in FIG. 1 and elsewhere; the concept of email-in to an online storage area for media (e.g., PickleBox); the concept of the multimedia slideshow; the concept of the ability to distribute content from the online storage area via data feeds (e.g., RSS and others); the polling of the data feed by the slideshow player to see if there are new items in the PickleBox to display; the concept of attaching a distribution list to a PickleBox and automatically forward items that are uploaded to the PickleBox to the distribution list (either email addresses or mobile phone numbers for MMS messages); the concept of automatic synchronization; the postal mail-in process; the Videogram concept; the Playable Media Indicator in the frame of the image. Many other features and attributes are apparent to one having ordinary skill in the art after consideration of the present disclosure. All such attributes, whether explicitly described above, or apparent to one having ordinary skill in the art, are within the scope of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for sharing multi-media files online, the system comprising:
a central server;
media files saved on the server in various logical groups, wherein each logical group can include different types of media files; and
a processor associated the server, wherein media files uploaded or emailed to the server automatically get stored in specific logical groups depending on a destination identifier for the emailed or uploaded file.

2. The system of claim 1, wherein the media files are selected from the list consisting of image files, audio files, and video files.

3. The system of claim 1, wherein the server can present the media files in a pre-determined order.

4. The system of claim 1, wherein access to the media files by multiple users is controlled by a single controller.

5. The system of claim 1, wherein a multi-media presentation created by the processor is available to viewers which may or may not be designated.

6. The system of claim 5, wherein the presentation can include image files, audio files, and video files.

7. The system of claim 1, wherein the media files are emailed to the central server.

8. The system of claim 7, wherein the emailed media files are automatically directed to a particular logical group on the server depending on the email address used.

9. A system for sharing multi-media files online, the system comprising:
a central server;
files saved on the server, wherein the files include different types of media stored in logical groups; and
a processor on the server, wherein the processor automatically presents the files in order.

10. The system of claim 9, wherein the central server comprises a plurality of hosts.

11. The system of claim 9, wherein the files are selected from the list consisting of image files, audio files, and video files.

12. The system of claim 9, wherein access to the files by multiple users is controlled by a single controller of the files.

13. The system of claim 9, wherein a multi-media presentation created by the processor is available to designated viewers.

14. The system of claim 13, wherein the presentation can include image files, audio files, and video files.

15. The system of claim 9, wherein the files are emailed to the central server.

16. The system of claim 15, wherein the emailed files are automatically included in a particular location on the server depending on the email address used.

17. A method for sharing multi-media files online, the method comprising:
automatically uploading a plurality of multi-media files onto a logical group within a central server; and
presenting the files in order.

18. The method of claim 17, wherein the multi-media files are selected from the list consisting of image files, audio files, and video files.

19. The method of claim 17, wherein the order is set by a user.

20. The method of claim 17, wherein access to the files by multiple users is controlled by a single controller of the files.
